(19) United States
(12) Patent Application Publication
(10) Pub. No.: US 2014/0352401 A1
(43) Pub. Date: Dec. 4, 2014

(54) ORIFICE SYSTEM

(71) Applicant: ROXAR Flow Measurement AS, Bergen (NO)

(72) Inventor: Terje Baustad, Stavanger (NO)

(73) Assignee: Roxar Flow Measurement AS, Bergen (NO)

(21) Appl. No.: 14/368,462

(22) PCT Filed: Feb. 6, 2013
(86) PCT No.: PCT/EP13/52289

§ 371 Date: Jun. 24, 2014

(30) Foreign Application Priority Data
Feb. 6, 2012 (NO) 20120120

(51) Int. Cl. G01F 1/42; G01L 27/00; G01F 25/00

(52) U.S. Cl. CPC G01F 1/42; G01F 25/00; G01L 27/002
USPC 73/1.71; 73/861.58

(57) ABSTRACT

The invention relates to an orifice system, especially for flow measurements in pipes, comprising a hinged member being adapted to be moved between two positions, the first position essentially covering the pipe cross section, and a second position into a recess outside the pipe cross section, wherein the hinged member has an opening thus in the first position allowing the fluid flow only through the opening. The invention also relates to a method for using the orifice system for calibrating pressure sensors mounted upstream and downstream of the orifice.

This invention relates to an orifice system for flow measurements, especially for flow measurements in pipes.

For multiphase meters flow restrictors such as venturis are often used for obtaining a differential pressure in a fluid flow. Such flow meters are discussed in U.S. Pat. No. 4,829,831 and EP 1173734 A problem with the ventttri described in these publications is that it represents a permanent restriction in the pipe and may have to be removed for example when minting through a pig (the term “pig” is hereafter used for any tool that may need to pass the orifice position in the pipe) for performing pipe maintenance and cleaning.

Other solutions have been tried such as placing a removable plate with an opening in the flow U.S. Pat. No. 5,617,899 and U.S. Pat. No. 4,712,585, and measuring the resulting differential pressure or pressure difference. This, however, is inconvenient e.g. for subsea or downhole applications as the complete unit containing the plate when removed from the flow is relatively large and thus difficult to seal. Another known solution is described in U.S. Pat. No. 4,790,194 constituting an iris providing a variable opening. This is, however, technically complicated and thus not suitable installation in non accessible installations on a permanent basis. It is also difficult to obtain a sufficiently accurate size of the opening to obtain reliable information related to the pressure differences and thus the flow rate in the pipe. Yet another orifice solution is shown in US2009/026555 where the orifice plate is moved into or out of the flow.

Thus it is an object of this invention to provide a flow measuring system for providing reliable flow measurements in inaccessible locations such as subsea and/or downhole environment and other situations where a compact, sealed solution is required. The object is obtained as described in the accompanying claims

The invention thus provides a solution where the pressure sensors may be calibrated by removing the orifice. If a pressure difference is measured the resulting measurement should be P1−P2=0, and if two individual pressure sensors are used P1=P2. This will provide a means for improving the accuracy of the pressure measurements and also the flow rate or other parameters calculated from the measurements. As the pressure sensors may be calibrated within fairly short periods of time, the more inexpensive, commercially available, independent pressure sensors may be used thus reducing the cost of the system.

The invention will be described more in detail with reference to the accompanying drawings, illustrating the invention by way of examples.

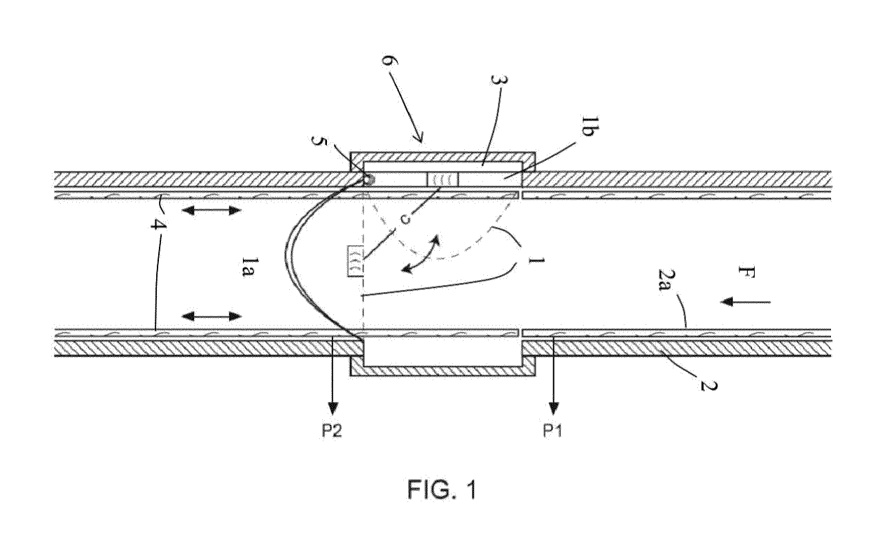

FIG. 1 illustrates a cross section of the preferred embodiment of the invention.

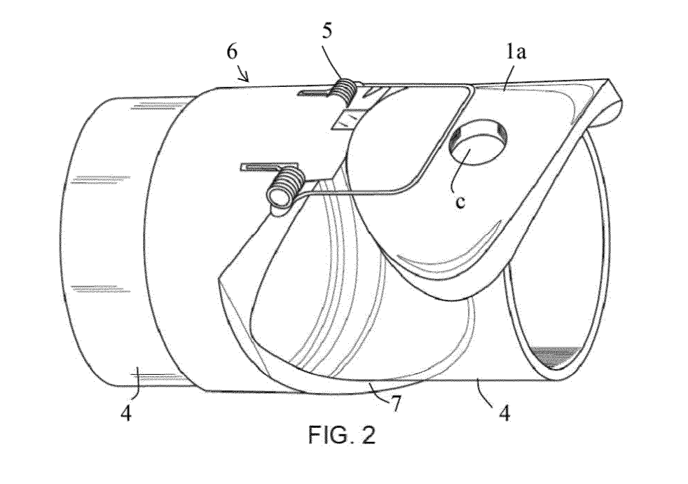

FIG. 2 illustrates a perspective drawing of the preferred embodiment of the invention in an open position.

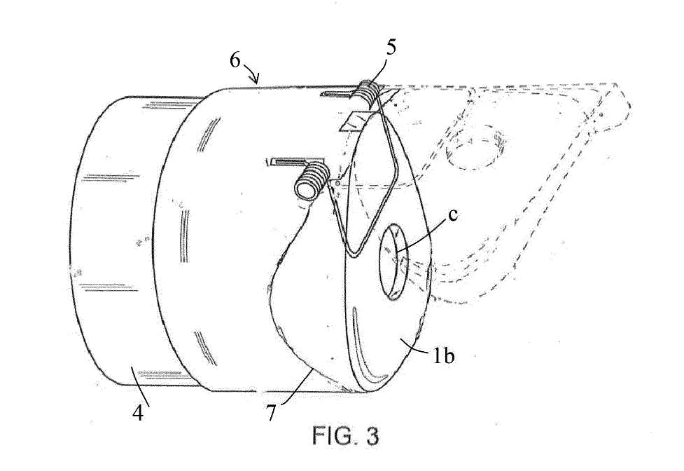

FIG. 3 illustrates a perspective drawing of the preferred embodiment of the invention in a closed position.

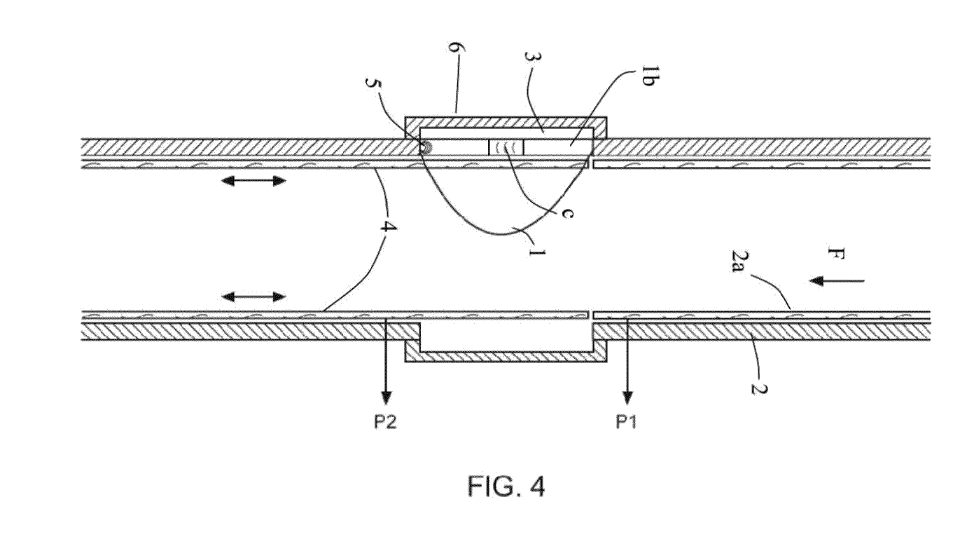

FIG. 4 illustrates the preferred embodiment of the invention in an open position.

As is seen in the drawings the orifice unit 6 is constituted by a hinged plate 1 having at least one opening c mounted in a pipe 2. In the first position 1a the orifice plate 1 is positioned in the flow F thus partially hindering the flow and positioning the orifice in the flow. Thus the pressure in front of P1 and after P2 the orifice may be measured as is well known in the art through openings (not shown) in the pipe wall 2. The pressure sensing means used for measuring P1 and P2 may, as mentioned above, be any unit suitable for the environment and coupled to a measuring unit (not shown) for providing a differential signal or two signals representing the two signals from the at least two pressure sensors. The realization of the pressure sensors may differ depending on the situation, either being constituted by sensors directly in communication with the fluid flow or through channels communicating the pressures P1,P2 to differential pressure sensors or pressure sensors having a retracted position relative to the fluid flow.

In the first position of the orifice plate the signals from the pressure sensors provide a measure of the fluid flow and in the second position the measure unit may adjust the signals or the interpretation of the signals so as to indicate no measured difference between P1 and P2, thus calibrating the output. Thus a calibration may be provided of the pressure signals.

The opening c is preferably positioned in the centre of the flow, but other solutions, both involving off centre positions and several openings, may be possible depending on flow conditions and pressure.

The orifice plate 1 shown in the drawing is spring loaded 5 so as to enter into the active position 1a and in the illustrated example the flow F direction also will contribute in keeping the orifice into the active position. As the position of the orifice plate is well defined in the flow, covering the complete cross section of the pipe, the position of the opening c in the plate is also well defined, which is advantageous as discussed in the abovementioned U.S. Pat. No. 5,617,899.

According to the preferred embodiment the orifice is opened by using an inner, actuator pipe 4 being moveable in the pipe direction and thus push the orifice plate against the spring and flow direction into the second position 1b in a suitable recess 3 in the pipe wall, as is shown in FIGS. 2 and 4. In this position the actuator pipe 4 has the same diameter as the inner surface 2a of the pipe 2 and thus provide an essentially continuous surface passed the orifice unit. Thus, during pipe maintenance a service tool, such as a pig, may pass the orifice unit unhindered and when calibrating the pressure sensors or sensing means the pressure upstream and downstream are essentially the same.

As is seen from the drawings the orifice plate 1 has a curved shape where the curvature corresponds to the curvature of the pipe wall, so as to fit into the recess 3, and the plate circumference corresponds to the cross section of the inner wall so as to close the pipe with exception of the orifice opening. Preferably a corresponding seat 7 is provided in the pipe wall so as to seal the orifice plate edges against the wall.

Other plate shapes are possible, such as a flat orifice plate, but this will require a larger recess and thus a less compact solution. On the other hand the adaption of the seat 7 will be easier with a flat orifice plate.

The inner actuator pipe 4 may be moved back and forth with any suitable known solution, such as hydraulic, magnetic or electric actuator means (not shown) and will not be described in detail here. The chosen actuator solution will depend on the required force for moving the orifice plate against the flow direction, and also the possibility for sealing the actuator means against the environment.

It is also possible to place a series of retractable orifices according to the invention, e.g. with different opening sizes. They may be controlled using the same actuator pipe and possible pressure sensors or being operated as separate units.

As an alternative to the actuator pipe it is also possible to use a controllable hinge, being electrically or hydraulically powered, thus possibly omitting the spring 5. This may, however, require accurate fitting of the plate into the recess to avoid turbulence caused by the mechanism.

Thus to summarize the invention relates to a retractable orifice 6, especially for flow measurements in pipes, for example in pipelines carrying multiphase hydrocarbon fluids. The orifice is included in a measuring unit measuring flow rate through measuring the pressure difference P1,P2 between positions upstream and downstream of the orifice. The measuring unit may also measure parameters such as density, permittivity et in the flow in order to indicate the composition of the fluid flow in a per se known multiphase meter as in the abovementioned publications.

The orifice comprises a hinged member constituted by a orifice plate 1 being adapted to be moved between two positions 1a, 1b. The first position 1a essentially covers the pipe cross section, and a second position 1b into a recess 3 outside the pipe cross section. The hinged member constituted by a orifice plate 1 having an opening c, so that it in the first position la allows a certain amount of fluid to pass through and thus provide a pressure difference upstream and downstream of the orifice plate. In the second position the hinged member is adapted to let the fluid pass unhindered.

The retractable orifice unit 6 preferably comprises an actuator unit for controllably moving the hinged member between said first and second position. The preferred actuator unit is constituted by an inner pipe 4 and an actuator for moving said inner pipe in the axial direction between a first actuator position, where the hinged member is allowed to be in said first position, and a second actuator position, where the inner pipe is forces the hinged member into the second position where it is positioned behind the inner pipe in a suitable recess in the pipe wall. The inner pipe 4 thus covering said recess 3 containing the hinged member 1 and letting the fluid pass unhindered through the pipe. The hinged member preferably includes a spring 5 providing a force toward said first position the inner pipe thus pushing against the spring when removing the orifice plate from the flow. If the flow rate is sufficiently large it is possible to omit the spring and let the fluid flow push the orifice plate into the first position.

The inner pipe 4 should have essentially the same dimensions as the rest of the pipe has outside the actuator unit.

The orifice plate in the hinged member may for example have a plane shape but preferably has a curved shape, the curved surface having essentially the same curvature as the circumference of the inner surface of the pipe, thus in the second position in said recess essentially constituting an extension of the pipe wall outside said inner pipe. In order to avoid fluids passing by the edges of the orifice plate the pipe wall providing a seat having a shape corresponding to the outer edges of the orifice plate and preferably a sealing body for sealing against the orifice plate.

The retractable orifice according to the invention also comprises pressure measuring including sensing means P1, P2 on both sides of said hinged member relative to the flow direction, the pressure sensing means communicating with the flow to detect the pressure through suitable openings in the pipe wall. The pressure sensing means may be constituted by a differential pressure sensor measuring the pressure difference between said two openings or measure the pressure for later analysis. The measuring unit (not shown) being part of the pressure measuring means is coupled to the pressure sensors and adapted to, when the orifice is open in the second position, to calibrate the sensors by adjusting the pressure difference to be zero or the two measured pressures to be equal. This may be performed in per se known ways and will not be discussed in detail here. When the orifice is positioned in the flow the measuring unit communicating the pressure information, e.g. signals related to the two pressure sensors or the difference between them, to other, e.g. topside, installations.

Thus the invention also relates to a method for calibrating pressure sensors using a retractable orifice according to the invention, where the hinged member being in the second position and the sensors proving a measure of the pressure or pressure difference between the sensors P1,P2, and adjusting the output from the sensors so as to indicate no pressure difference between the upstream and downstream sensors when the hinged member is in the second position.

The solution also provides a switchable orifice which may be opened to allow a pig to pass through the pipe, while also maintaining a clearly defined opening. Preferably the orifice in the active position is sealed against a corresponding seat in the pipe wall so as not to let fluids bypass the opening, and the shape of the orifice plate is curved so as to fit closely into the pipe wall in the opening, inactive, position.

1. An orifice system for flow measurements in pipes, the orifice system comprising:
a hinged member being adapted to be moved between two positions, the first position essentially covering the pipe cross section, and a second position into a recess outside the pipe cross section;
wherein the hinged member has an opening thus in the first position allowing the fluid flow only through the opening; and
at least one pressure sensing means on each side of said hinged member relative to the flow direction, said pressure sensing means being coupled to a measuring unit comparing the pressure on each side of the hinged member when being positioned in said first or second position.

2. The orifice system according to claim 1, comprising an actuator unit for controllably moving the hinged member between said first and second position, the actuator unit being constituted by an inner pipe and an actuator for moving said inner pipe in the axial direction between a first actuator position wherein the hinged member is allowed to be in said first position and a second actuator position wherein the inner pipe is forces the hinged member into the second position and also covering said recess containing the hinged member.

3. The orifice system according to claim 1, wherein said hinged member includes a spring providing a force toward said first position.

4. The orifice system according to claim 1, said inner pipe has essentially the same inner diameter as the pipe in said pipeline outside said actuator unit.

5. The orifice system according to claim 1, wherein the hinged member has a curved surface, the curved surface having essentially the same curvature as the pipe circumference, thus in the second position in said recess essentially constituting an extension of the pipe wall outside said inner pipe.

6. The orifice system according to claim 1, wherein said hinged member in said first position closes against a should in said pipe wall providing a seal hindering fluid to pass through said hinged member edges.

7. The orifice system according to claim 1 said measuring unit being adapted to calibrate the sensors when the hinged member is in the second position and thus being retracted from said flow.

8. A method for calibrating pressure sensors using a orifice system as described in clam 1, the hinged member being in the second position, from said sensors proving a measure of the pressure or pressure difference between the sensors, and adjusting the output from the sensors so as to indicate no pressure difference when the hinged member is in the second position.
